(19) United States
(12) Patent Application Publication
(10) Pub. No.: US 2024/0194099 A1
(43) Pub. Date: Jun. 13, 2024

(54) Reflector Device, Method For Producing A Reflector Device, And Motor Vehicle Comprising A Reflector Device

(71) Applicant: AUDI AG, Ingolstadt (DE)

(72) Inventors: André GEORGI, Eching (DE); Michael PRADEL, Manching (DE)

(73) Assignee: AUDI AG, Ingolstadt (DE)

(21) Appl. No.: 18/285,184

(22) PCT Filed: Feb. 22, 2022
(86) PCT No.: PCT/EP2022/054295

§ 371 Date: Sep. 29, 2023

(30) Foreign Application Priority Data
Mar. 31, 2021 (DE) 10 2021 108 140.8

(51) Int. Cl. G09F 13/04; G09F 13/14

(52) U.S. Cl. CPC G09F 13/0422; G09F 13/14

(57) ABSTRACT

A reflector device includes a reflector element having a reflection surface that reflects light waves incident on the reflection surface. The reflector element has a predefined shape and a rear side situated opposite the reflection surface. The reflector device has a shell element having a depression to receive the reflector element. The reflector element is mounted in the depression such that the reflection surface of the reflector element faces away from the depression. The reflector device has a covering element having a transparent portion, through which the reflection surface of the reflector element is visible. The covering element is arranged against the shell element to form a container for the reflector element.

### TECHNICAL FIELD

The invention relates to a reflector device, a method for producing a reflector device, and a motor vehicle comprising a reflector device.

### BACKGROUND

A reflector device is understood to mean a component or assembly which reflects light. The element of the component or of the component group which is configured to reflect the light is referred to as a reflector element. The surface of the reflector element which reflects the light is referred to below as a reflection surface.

Reflectors of motor vehicles are frequently arranged on their rear side in order to reflect, for example, headlamp light of following vehicles such that it can be seen by their drivers. As a result, the risk of collision accidents can be reduced.

U.S. Pat. No. 7,011,418 B2 describes a retroreflective covering film or strip which is suitable for the sides of load trains and comprises alternating red and white colors which are separated by made-to-measure surfaces of the cover film or the strip at predetermined points and lengths. Such a strip or cover film is very complicated to produce.

DE 20 2018 006 359 U1 describes a motor vehicle with a front windshield, a rear window, and at least two side windows with at least one element arranged on the outer surface of the motor vehicle, which element can in particular be viewed on an oncoming vehicle on an opposite lane and/or by another vehicle following the motor vehicle, wherein at least one retroreflector element having a plurality of reflective microprisms is arranged on the element.

EP 0 004 976 B1 relates to a universal warning strip which is primarily intended for attachment to the rear side of land vehicles, and in particular to vehicles intended for road traffic.

DE 20 2009 013 886 U1 discloses exterior trim parts and sealing arrangements for windows, doors, and roofs, as well as covers for vehicles which are made of a surface wherein the surface material has reflective or retroreflective properties.

US 2003/0142505 A1 describes a motor vehicle light arrangement comprising a reflector which has apertures formed in its circumferential wall which are configured to accommodate light-emitting diodes in an orientation generally perpendicular to the circumferential wall.

If a reflective film is simply glued to the vehicle body, the film is not protected against external influences, e.g., the weather, and can be torn off, for example, by passing pedestrians. Such a film is generally damaged by rain, erosion, and headwind, external mechanical forces, i.e., for example, pedestrians who pull on the film, or in the car wash, and does not remain permanently mechanically positioned, and can even lose its reflective power. The adhesion of a reflective film is also hardly suitable for mass production, since the film must be positioned and glued on manually. If the film is to be repositioned or something else is to be glued, traces or possibly damage to the paint can remain, or the adhesive can dry, and the film can peel off more quickly after a repositioning. In addition, it is rather disadvantageous that a strong adhesive reduces the probability of film slippage, but can have a greater influence on the paint—in particular, when the film is removed. A less strong adhesive, on the other hand, can easily be softened by rain in certain circumstances, so that the film slips or even completely peels off.

As an alternative to reflective films, for example, a region of the motor vehicle can be illuminated at night with LED's, and in particular with LED's from the inside, in order to increase the perceptibility of a warning sign on the motor vehicle, for example. However, it is disadvantageous in this case that this is very expensive, and that LED's can fail at some point so that, for example, a marking for a police car or for an ambulance does not fully shine. Additional disadvantages are the energy consumption of the LED's and the large amount of required installation space. Such lighting can nevertheless fail completely after a small impact with only minor damage. If the vehicle is parked and switched off, the region is either not illuminated, or the battery of the motor vehicle is drained. In some countries, active illumination by means of lamps may also not be permitted.

### SUMMARY OF INVENTION

An object upon which embodiments of the invention is based is a particularly efficient highlighting of a region of a motor vehicle by light.

The object is achieved by the devices according to embodiments of the invention and the method according to the invention in accordance with the independent claims. Advantageous developments are provided by the dependent claims.

Embodiments of the invention is based upon the idea of using a reflector element instead of active lighting and integrating it into a component (or component group) designed as a covered shell or container. The shell or the container can be glued or clipped to a desired location—for example, an exterior of the motor vehicle.

The reflector element is mounted in a shell and is shielded from external influences by an at least partially transparent cover in the form of a covering element. In this case, the covering element, which can be designed, for example, as a cover plate, is preferably completely transparent or substantially or largely transparent, so that the reflector element, which has the shape of a desired logo, symbol, or lettering, or a desired symbol sequence, is visible from the outside. In daytime, the reflector element which can form a letter string or a symbol, for example, is clearly visible and reflects back luminously at night when light falls onto the reflector element. The reflector element forming the reflection is accordingly visible both day and night, i.e., the exemplary symbol is always the same in both its day and night appearance. Preferably, the shape of the reflector element, i.e., its outline, can also determine the shape of the covered shell or container.

The reflector element in its predefined shape, i.e., in an outline as, for example, a symbol, e.g., as a warning symbol, is easily visible during the day and at night, wherein the night visibility results from the fact that it is illuminated, for example, by traffic, i.e., for example, by other road users, and reflects the headlamp light. Due to the position of the reflector element in the depression or trough, the exemplary symbol cannot be seen, or cannot be well seen, by pedestrians, but, for example, it can be seen by car drivers or cyclists since the light of the headlights of the other (motor) vehicles is reflected. In comparison to active lighting by means of, for example, LED's, it is very convenient and requires significantly less installation space. There is, therefore, no additional energy consumption. The reflection is not vulnerable and does not fail. For example, rain or dirt does not fall directly onto the reflector element, and the covering element and the shell element can easily be cleaned. In other words, the covering element fulfills the function of a protective layer.

The reflector element functions even after a small impact. The reflector element is also visible when the motor vehicle is parked. The solution according to embodiments of the invention is also very suitable for mass production, since the reflector device does not necessarily have to be glued on manually, in contrast to a reflector film. Another positioning advantage is that the positioning is very long-lasting.

The reflector device is particularly advantageous if it is produced by means of an injection-molding method, e.g., by back-molding or overmolding the reflector element in a single-component injection-molding method or, preferably, in a two-component injection-molding method. As a result of the injection molding, the covering element and shell element are fastened tightly to one another so that, for example, no water can enter the interior of the shell. The reflector device then does not have a gap, and is accordingly encased very tightly. The reflector element is thereby better protected against erosion.

The reflector device according to the invention is preferably for a motor vehicle, and preferably for being arranged on an exterior of the motor vehicle, i.e., for example, on a body—for example, on a door or on a radiator grill. Alternatively, the reflector device can be used as a plate, for example. However, the particular advantages of suitability for mass production come into play above all with a reflector device for a motor vehicle according to the invention, because it also improves the suitability for mass production of the corresponding motor vehicle.

The reflector device according to the invention has a reflector element with a reflection surface which is configured to reflect light waves incident on the reflection surface. The reflector element has a predefined shape. The predefined shape in this case describes, for example, the logo, the lettering, a letter, a symbol, or a symbol sequence, and is therefore form-giving for the reflection. The reflector element has a rear side situated opposite the reflection surface and is designed to be flat—for example, as a strip or plate.

The reflection surface of the reflector element deflects back the incident light waves in the direction of incidence of the light waves. In other words, the reflector element is a retroreflective reflector element. In contrast to, for example, a mirror, the retroreflective reflector element shines much more brightly. The light is reflected irrespective of the direction from which the light is coming. With such a reflector element, the reflection surface can have, for example, glass beads and/or glass powder and/or microprisms. The reflector effect is much more intense, i.e., very much brighter, which particularly when affixing the reflector device on the outside of the motor vehicle—significantly intensifies the aforementioned advantages.

The reflector element is designed as a retroreflective film. The reflector device can accordingly be constructed to be very flat and light, and a very bright reflector can be provided in combination with the retroreflective property very efficiently and compactly.

The reflector device comprises a shell element which has a depression or trough which accommodates the reflector element. In other words, the depression or the trough has a shape into which the reflector element fits, which therefore accommodates the reflector element. The logo, the symbol, or the symbol sequence or the lettering of the reflector element is then also highlighted more clearly even during the day.

As a result, the shell element, which can be opaque, for example, can position the reflector element very well even without gluing. The shell element can give the entire reflector device a characteristic shape, viz., for example, the shape of the exemplary symbol sequence, if not just the depression or trough, but the entire shell element has the shape of the outline of the reflector element.

The reflector element is mounted in the depression or trough such that the reflection surface faces away from the depression. The rear side of the reflector element is then facing the depression. If the reflector element is accordingly in the depression or trough of the shell element, the reflection surface is still visible.

The reflector device includes a cover member having a transparent portion through which the reflective surface of the reflector element is visible. The covering element and the shell element are arranged against one another in such a way that they form a covered container or a covered shell for the reflector element mounted in the depression or trough.

The transparent portion of the covering element preferably has the shape of the reflector element or completely reveals the view of the reflection surface of the reflector element. In other words, ideally, the entire logo or symbol, the entire symbol sequence, or the entire lettering can be visible—preferably the entire reflection surface mounted in the shell element in the predefined shape.

The predefined shape means the shape that, for example, the logo, the lettering, or the symbol sequence assumes, i.e., the outline of the reflector element. If the predefined shape of the reflection surface (and accordingly of the reflector element) is, for example, the shape of the letter “P,” the transparent portion of the reflector element is designed and is large enough that the P is also discernible and visible from the outside. The covering element can preferably be completely transparent.

This results in the aforementioned advantages.

As already mentioned above, the predefined shape of the reflector element can, for example, be a symbol or a symbol sequence, i.e., form a symbol or a symbol sequence for example, a letter or a letter sequence. The combination of shape and reflection is particularly effective in communicating information at night, since, for example, an identification of a police vehicle with the reflective lettering, “police,” or, for example, a warning symbol, can be seen much better.

The shape of the depression of the shell element can preferably correspond to the predefined shape of the reflector element. Ideally, the reflector element can fit snugly in the depression or trough. This ensures a particularly good hold. In order to additionally emphasize the exemplary lettering by also using the shell element as an information carrier due to its shape, the shape of the shell element corresponds to the predefined shape of the reflector element. The shell element gives the entire reflector device a characteristic shape, viz., for example, the shape of the exemplary symbol sequence.

In another embodiment of the reflector device according to the invention, a shape of the covering element can correspond to the shape of the shell element. In other words, the cover element and shell element then fit over each other exactly. This makes the reflector device particularly handy and able to be easily integrated into or on a motor vehicle, and increases a design aspect.

If the shape of the covering element and the shape of the shell element correspond to the predefined shape of the reflector element, the entire reflector device reproduces the exemplary symbol sequence by its characteristic shape. The exemplary logo or symbol, or the symbol sequence or the lettering of the reflector element, are then also highlighted more clearly even during the day.

According to another preferred embodiment of the invention, the reflector device includes a shell element having [has] a base element, i.e., a portion which forms a base in which the depression or trough is located. The covering element then surrounds this base with the depression or trough. This creates a special depth effect of the reflection in incident light. The attention of another road user is accordingly even better focused upon the reflector element.

The object stated above is achieved by a method for producing a reflector device according to one of the embodiments described above. The method comprises providing the reflector element which is configured as a retroreflective film and has the predefined shape.

Preferably, one or more walls of the base element can flank the depression such that the reflection surface is recessed into the base element, and the walls project beyond the reflection surface. The wall(s) can then also be termed a flank element or a shading element which shades the reflection surface against laterally incident ambient light. On the one hand, this means that, at night, the reflected light can be seen only from a restricted viewing angle. In addition, the reflection surface is protected against lateral ambient light during the day, so that erosion by sunlight, i.e., by UV radiation, is reduced.

The method also comprises arranging the shell element and the at least partially transparent covering element on the provided reflector element by injection molding such that the shell element is arranged on the rear side of the provided reflector element, and the covering element is arranged on the shell element such that the reflection surface of the reflector element faces the partially transparent covering element. The injection-molding method can preferably comprise back-molding or overmolding. The sequence of the arrangement of shell element and covering element is irrelevant here. The arrangement of the shell element and covering element can also take place simultaneously.

Preferably, the method can be a two-component injection-molding method. A preferred procedure of the two-component injection-molding method can be that, first, the shell element is injection-molded as the first component, and then the mold top side is removed. Thereafter, the reflector element—preferably a retroreflective film—can be arranged in the depression—for example, glued or otherwise applied. After application of another (i.e., alternative) mold top side, the combination of the shell element and reflector element can be overmolded with a clear component—preferably only with one clear component—wherein the latter then forms the covering element. A clear component is understood to mean a transparent plastic. It is advantageous that the reflector element is enclosed completely in the component and cannot become soiled. In contrast to a multi-part construction, liquids, e.g., rain or spray water—and accordingly impurities—cannot enter.

The advantages have already been mentioned above. The reflector element is particularly well protected against external influences, and the shell is particularly tight.

Preferably, the method can comprise arranging the reflector device in or on a motor vehicle, e.g., clipping or gluing to an exterior of the motor vehicle—for example, on the body or on the radiator grill. The method can then also be termed a method for providing a reflector device on a motor vehicle, or a method for providing a motor vehicle.

The object stated above is also achieved by a reflector device which is produced by an embodiment of the method according to the invention. This results in the aforementioned advantages.

The object stated above is achieved by a motor vehicle having the reflector device according to an embodiment of the invention. The motor vehicle according to an embodiment of the invention is preferably designed as an automobile, and in particular as a passenger car or a truck, or as a passenger bus or a motorcycle.

Preferably, the reflector device can be arranged on an exterior of the motor vehicle, i.e., for example, on the body, and in particular on a tailgate, on an engine hood, on a door, or on a radiator grill. Accordingly, other road users can easily see the reflector element and, for example, be warned early on. The protective function of the covering element is particularly good in the variant in which the reflector device is arranged on the exterior, since it protects the reflector element from contamination and corrosion. Preferably, the reflector device can be arranged on a motor vehicle front—in particular, on a radiator grill—and/or on a vehicle rear. At these locations, the reflector element is illuminated either by oncoming traffic and/or by following vehicles; the exemplary logo or symbol is accordingly visible particularly well due to the reflection.

The invention also includes a method according to further embodiments of the invention and of the motor vehicle according to an embodiment of the invention which have features as already described in connection with the further embodiments of the reflector device according to the invention. For this reason, the corresponding developments of the method according to embodiments of the invention and the motor vehicle according to embodiments of the invention are not described again here.

The invention also comprises the combinations of the features of the described embodiments. The invention therefore also comprises implementations which each have a combination of the features of several of the described embodiments, provided the embodiments have not been described as mutually exclusive.

### BRIEF DESCRIPTION OF THE FIGURES

In the following, exemplary embodiments of the invention are described. In the figures:

FIG. 1 shows a schematic representation of a reflector device according to an embodiment of the invention in cross-section;

FIG. 2 shows a front view of another schematic representation of the exemplary reflector device;

FIG. 3 shows a schematic three-dimensional representation of the exemplary reflector device of FIG. 2;

FIG. 4 shows a schematic representation of the motor vehicle with a reflector device; and

FIG. 5 shows a schematic representation of the method according to an embodiment of the invention.

### DETAILED DESCRIPTION OF THE FIGURES

The exemplary embodiments described below are preferred embodiments of the invention. In the exemplary embodiments, the described components of the embodiments each represent individual features of the invention that are to be considered independently of one another, each also further developing the invention independently of one another. For this reason, the disclosure is also intended to include other combinations of the features of the embodiments than those described. Additionally, the described embodiments can also be complemented by additional, already described features of the invention.

In the figures, the same reference signs refer to functionally identical elements.

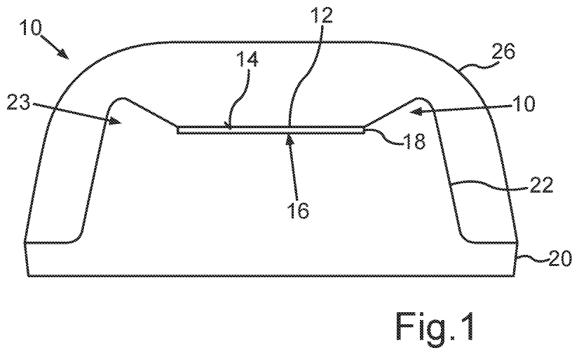

FIG. 1 illustrates the principle of the reflector device 10 according to a first exemplary embodiment of the invention. In FIG. 1, the reflector device 10 is shown in a cross-section. Preferably, the reflector device 10 can be designed as a component for a motor vehicle (not shown in FIG. 1), or, for example, as a plate or accessory for a bag.

The reflector device 10 of FIG. 1 has a reflector element 12 which can preferably be configured as a retroreflective film. By way of example, the reflector element 12 can be mirrored, for example, i.e., have a silver coating, or can be coated, for example, with glass beads, glass powder, and/or microprisms. Suitable materials for reflective or retroreflective films or plates are known to the person skilled in the art from the prior art and are available in various qualities from different manufacturers. The reflector element 12 can, for example, form a logo, lettering, or symbol sequence, or a symbol.

The reflector element 12, and in particular a reflector element 12 designed as a film, can, for example, be planar (i.e., level or flat), or for example bent once or curved, bent twice or curved, or twisted. A curved reflector element 12 can preferably be bent along its length, for example, and/or can be or form a relief.

The rear side 16 situated opposite the reflection surface 14 can optionally be a carrier material known to a person skilled in the art from the prior art.

FIG. 1 shows the principle that the reflector element 12 with the rear side 16 lies in a depression 18, which can also be referred to as a “trough.” Preferably, the shape of the depression 18 can correspond to the shape of the reflector element 12, so that the reflector element 12 can, for example, be easily inserted into the depression 18 and thereby held. Alternatively, the reflector element 12 can, for example, be glued or clamped in the depression 18. The depression 18 is formed by the shell element 20, which can preferably be made of a plastic. The example of FIG. 1 shows a shell element 20 with a base element 22, which can form a partial body of the shell element 20 that forms the depression 18. Preferably, a wall 23 of the base element 22, as shown in FIG. 1, can flank the depression 18 such that the reflection surface 14 is recessed into the base element 22, and the walls 23 project beyond the reflection surface 14. The walls 23 can then also be termed a “shading element” that shades the reflection surface 14 from laterally incident ambient light. The height of the wall or walls 23 can then be individually predetermined according to the purpose.

The reflector device of FIG. 1 also shows an optional holding element 24, e.g., a clip for fastening the reflector device 10 to, for example, a radiator grill of a motor vehicle.

FIG. 1 further shows the covering element 26, which can preferably be completely transparent. The transparent portion of the cover element 26 is ideally large enough that the complete reflector element 12 is visible when looking towards the cover element 26, or at least that a shape of the reflector element 12 is visible and detectable through the cover element 26. The covering element 26 can preferably consist of a transparent plastic. FIG. 1, which shows the variant with a shell element 20 that has a base element 22, also shows that the covering element 26 can surround the base element 22. The covering element 26 can ideally consist of a plastic or comprise such a plastic as has UV protection for example, a component which is known from the prior art and repels UV light.

Ideally, the covering element 26 and shell element 20 can be formed by an injection-molding method, so that the covering element 26 preferably completely or almost completely covers the reflector element 12. Such an air-free or virtually air-free closure prevents erosion and contamination of the reflector element 12.

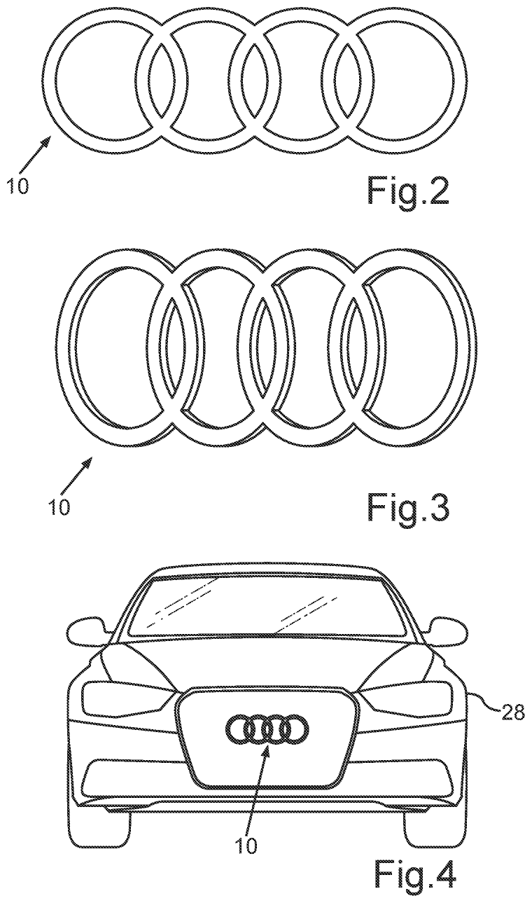

FIG. 2 shows a preferred exemplary embodiment of a reflector device 10 in a plan view in which the reflector element 12 has, for example, the shape of a logo. For reasons of greater clarity, the details of the reflector element 12 of FIG. 2 are not indicated. In its construction, the reflector device 10 can preferably correspond to the example of FIG. 1 or a reflector device 10 which does not have a base element 22. The plan view of FIG. 1 illustrates that the reflector device 10 per se can preferably have the same shape as the symbol formed by the reflector element 12. This is clearly illustrated in the three-dimensional representation in FIG. 3. Preferably, therefore, the covering element 26 and shell element 20 can also be formed in the shape of the logo. For reasons of greater clarity, covering element 26 and shell element 20 are not specifically highlighted in FIG. 2 and in FIG. 3.

FIG. 4 shows an example of a motor vehicle 28, e.g., a passenger car, on which a reflector device 10, for example, can be glued, clipped, or screwed onto an exterior, i.e., for example, on a radiator grill. Alternatively or additionally, the reflector device 10 can be arranged on a body part and/or on a tailgate or trunk lid, or, for example, on an outer side of a door of a motor vehicle 28. In daylight, the logo can be visible, for example, by a reflector element 12 designed as a white film, wherein the exemplary film normally does not reflect during the day because the headlights of other vehicles are usually switched off during the day.

The reflector element 12 of FIG. 4 can, for example, have a shape of a logo, with a reflector element 12 in the shape of the logo. The structure can, for example, be that of the reflector device 10 of FIG. 1 and/or of FIG. 2 and/or FIG. 3.

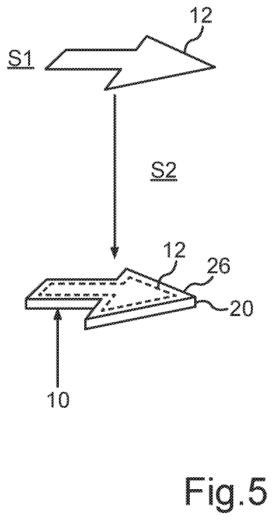

FIG. 5 illustrates the principle of the method in which the reflector element 12, e.g., a retroreflective film in a predefined shape, can, in the first method step S1, be provided in that the reflector element 12 is, for example, provided, or the provision S1 can optionally comprise the production of the reflector element 12.

In method step S2, the shell element 20 and the at least partially transparent covering element 26 are arranged using an injection-molding method—preferably from the same or different plastics. Preferably, the arrangement S2 can be carried out by overmolding the reflector element 12, or, for example, first, by back-molding the reflector element 12 to arrange the shell element 20, and then arranging the covering element 26 by injection molding with another plastic.

In the example of FIG. 5, reflector element 12 and/or reflector device 10 have the shape of an arrow—preferably reflector element 12 and reflector device 10. Alternatively, however, reflector element 12 and reflector device 10 can also have a different shape—for example, the shape of the logo.

Overall, the examples show how a reflective surface, and preferably a retroreflective surface, can be provided, e.g., on an exterior of a motor vehicle 28 or on add-on parts in the shape of a logo, lettering, or a symbol sequence, for example. In this case, a reflector element 12, and preferably a retroreflective film, is, for example, cut out in the shape of the exemplary logo, lettering, or symbol or symbol sequence, and can be positioned by the reflector device 10 on the exterior of the motor vehicle 28.

1.-12. (canceled)

13. A reflector device comprising:
a reflector element having a reflection surface configured to reflect light waves incident on the reflection surface, the reflection surface having a predefined shape that is form-giving for the reflection, the reflector element having a rear side situated opposite the reflection surface, wherein the reflector element is a retroreflective film;
a shell element having a base element defining a depression configured to receive the reflector element, wherein the reflector element is mounted in the depression such that the reflection surface faces away from the depression; and
a covering element having a transparent portion through which the reflection surface of the reflector element is visible, and wherein the covering element is arranged against the shell element such that the covering element surrounds the base element to form a container for the reflector element,
wherein the covering element and the shell element are produced by back-molding the reflector element so that there is no gap within the reflector device, and
wherein a shape of the depression of the shell element corresponds to the predefined shape of the reflector element so that there is no gap between the reflector element and the base element.

14. The reflector device according to claim 13, wherein the reflection surface of the reflector element is configured to deflect the incident light waves back in a direction of incidence of the incident light waves.

15. The reflector device according to claim 13, wherein the predefined shape of the reflector element forms at least one of a symbol, a symbol sequence, a letter, or a letter sequence.

16. The reflector device according to claim 13, wherein a shape of the shell element corresponds to the predefined shape of the reflector element.

17. The reflector device according to claim 13, wherein a shape of the covering element corresponds to a shape of the shell element.

18. The reflector device according to claim 13, wherein a shape of the covering element and a shape of the shell element correspond to the predefined shape of the reflector element.

19. The reflector device according to claim 13, wherein the covering element comprises a plastic that includes a UV-light-repellent component.

20. A method for producing a reflector device, comprising:
providing a reflector element configured as a retroreflective film and having a predefined shape, wherein the reflector element has a reflection surface configured to reflect light waves incident on the reflection surface; and
forming a shell element and a covering element that is at least partially transparent on the reflector element by injection molding such that the shell element is arranged on a rear side of the provided reflector element, wherein the shell element has a base element defining a depression receiving the reflector element,
wherein the covering element is arranged on the shell element such that the reflection surface of the reflector element faces the partially transparent covering element.

21. The method according to claim 20, wherein the forming of the shell element and the covering element is a two-component injection-molding step comprising:
forming the shell element by injection molding;
after the injection molding of the shell element, removing a top side mold;
after removal of the top side mold, arranging the reflector element in the depression of the base element of the shell element;
applying a second top side mold; and
after the application of the second top side mold, overmolding the shell element and the reflector element received in the depression of the base element of the shell element with a clear component to form the covering element.

22. A motor vehicle comprising:
a reflector device comprising:
a reflector element having a reflection surface configured to reflect light waves incident on the reflection surface, the reflection surface having a predefined shape that is form-giving for the reflection, the reflector element having a rear side situated opposite the reflection surface, wherein the reflector element is a retroreflective film;
a shell element having a base element defining a depression configured to receive the reflector element, wherein the reflector element is mounted in the depression such that the reflection surface faces away from the depression; and
a covering element having a transparent portion through which the reflection surface of the reflector element is visible, and wherein the covering element is arranged against the shell element such that the covering element surrounds the base element to form a container for the reflector element,
wherein the covering element and the shell element are produced by back-molding the reflector element so that there is no gap within the reflector device, and
wherein a shape of the depression of the shell element corresponds to the predefined shape of the reflector element so that there is no gap between the reflector element and the base element.

23. The motor vehicle according to claim 22, wherein the reflector device is arranged on an exterior of the motor vehicle.
